(19) United States
(12) Patent Application Publication
(10) Pub. No.: US 2006/0115202 A1
(43) Pub. Date: Jun. 1, 2006

(54) Fibre optic based semiconductor micro sensors for sensing pressure or temperature, fabrication methods of said sensors, and a method of securing an optical fibre to a silicon block

(76) Inventors: Robert Stevens, Swindon (GB); Arnold Harpin, Oxford (GB)

Correspondence Address: BIRCH STEWART KOLASCH & BIRCH, PO BOX 747, FALLS CHURCH, VA, 22040-0747, US

(21) Appl. No.: 10/530,524

(22) PCT Filed: Oct. 8, 2003
(86) PCT No.: PCT/GB03/04362

§ 371 Date: Apr. 7, 2005

(30) Foreign Application Priority Data
Oct. 8, 2002 (GB) 0223361.7

(51) Int. Cl. G02B 6/00

(52) U.S. Cl. 385/12; 385/137

(57) ABSTRACT

An optical micro sensor (1) for measuring one or more environmental parameters, such as pressure and temperature, through the modification of incident radiation. The sensor (1) is fabricated using MEMS technology and is adapted to receive an optical fibre (40) which communicates radiation to and from the micro sensor (1). The sensor (1) has an environmentally-sensitive element (4) which modifies the incident radiation communicated by the optical fibre (40). The modified radiation is communicated back along the optical fibre (40) and provides information regarding the environmental conditions surrounding the sensor (1). The pressure sensor is provided with a Fabry Perot cavity (3) in a first surface of a silicon wafer (2). The cavity is covered by a reflector at the environmentally-sensitive element (4). The diameter of the channel (7) holding the optical fibre (40) is greater than the diameter of the cavity. (3). The temperature sensor is provided with luminescent material at the element (4). Also, a method of securing an optical fibre to a silicon block is claimed.

The present invention relates to an optical sensor for measuring one or more parameters through the modification of incident radiation and to the fabrication of such a sensor. The present invention particularly but not exclusively relates to micro devices such as a microelectromechanical system (MEMS) device adapted to receive an optical fibre and to modify radiation communicated via the optical fibre, the modification being dependent upon the environmental conditions including but not limited to pressure, temperature, fluid flow, pH, oxygen concentration, carbon dioxide concentration, glucose concentration, lactate concentration, bicarbonate ion concentration, chlorine ion concentration, sodium and potassium ion concentration, to which the MEMS is exposed.

In “Micromachined fibre optic Fabry-Perot pressure sensors for aerodynamics applications”, M J Gander et al., Applied Optics and Optoelectronics Conference, 2-5 September 2002, Cardiff, U.K., a sensor utilising a Fabry-Perot microcavity was described for measuring pressure. The Fabry-Perot cavity is formed by etching a well in the surface of a silicon substrate; the depth of the well corresponding to the length of the Fabry-Perot cavity. A deep second etch is then performed on an area of the silicon substrate encompassing the well. The well profile is approximately maintained during the deep etch which continues until the bottom surface of the well is completely removed and a copper film, disposed on the opposing surface of the silicon substrate, is revealed. This deep etch creates a channel having a diameter sufficient to accommodate an optical fibre. When the optical fibre is inserted into the channel, the well profile describes a Fabry-Perot cavity with the facing surfaces of the optical fibre and the copper film forming the reflective surfaces. Unfortunately, during the deep second etch the profile of the well structure is not accurately maintained. In particular, the depth of the well which determines the cavity length, cannot accurately nor predictably be formed. Accordingly, each sensor manufactured in this way requires calibration. Similarly, the diameter of the well cannot accurately nor predictably be formed. Accordingly, the exposed surface area of the copper film, which acts as the pressure membrane, and thus the response of the pressure sensor may also vary.

An alternative optical sensor for measuring temperature as well as pressure is described in EP-A-0392897. The sensor comprises a hemispherical elastomeric material which is attached to the end of the optical fibre. A reflective coating is provided on a region of the convex surface of the elastomeric material and a luminescent material is applied over the reflective coating and the remaining regions of the convex surface of the elastomeric material. On application of external pressure, the hemispherical elastomeric material is deformed and thus the degree of optical coupling between the reflective surface and the end of the optical fibre is changed. Accordingly, the intensity of the light reflected from the reflective coating changes. However, the elastic properties of the elastomeric material vary with temperature and thus the sensor is unsuitable for measuring pressure variations over a large temperature range.

Furthermore, excitation radiation striking the luminescent material causes the material to luminesce. The characteristics of the luminescent emissions communicated back along the optical fibre are temperature dependent and so monitoring the luminescent emissions provides a measure of the sensor's temperature. The sensor is of course dependent upon the intensity characteristics of the luminescent emissions transmitted by the optical fibre. However, the optical coupling between the optical fibre and the luminescent material is poor thus reducing the amount of light captured by the optical fibre. This problem is particularly acute where the sensor is required to respond to relatively rapid changes in temperature as in these circumstances the layer of luminescent material must be kept relatively thin e.g. a few microns, which further reduces the intensity of the luminescent emissions.

It is, of course, possible to achieve a good optical coupling where the end surface of the optical fibre is directly coated with luminescent material. However, this arrangement also suffers from low emission intensity because only emissions from the luminescent material in contact with the small fibre core is collected.

Moreover, commonly an optical fibre is secured to a micro sensor such as a MEMS sensor by means of an adhesive applied to the cladding of the optical fibre and the surface of the silicon substrate. However, repeated small displacements of the optical fibre with respect to the substrate over time can cause the adhesive to become separated from the substrate surface.

It is an object of this invention to provide a micro optical sensor which overcomes in part one or more of the aforementioned disadvantages of the prior art.

It is a further object to provide a micro optical sensor suitable for measuring a multiplicity of parameters including but not limited to pressure, temperature, fluid flow, pH, oxygen concentration, carbon dioxide concentration, glucose concentration, lactate concentration, bicarbonate ion concentration, chlorine ion concentration, sodium and potassium ion concentration.

It is further object to provide a low-cost, disposable micro optical sensor preferably having quick (sub-minute) reaction times and being suitable for in vivo medical applications.

Accordingly, in a first aspect the present invention provides a method fabricating an optical sensor comprising the steps of: providing a silicon substrate having a first surface and a second surface; providing a region comprising essentially of silicon dioxide on or in the first surface of the silicon substrate; etching a channel into the silicon substrate from said second surface up to said silicon dioxide region, said channel being sized to receive an optical fibre whereby said silicon dioxide region forms an end portion of said channel which at least partially closes said channel; and coating at least a portion of the silicon dioxide region with a coating to form an environmentally-sensitive element.

Preferably, the silicon substrate and silicon dioxide region form a single substrate element requiring no additional substrate elements to form the optical sensor.

The silicon substrate is preferably monolithic.

The step of providing the silicon dioxide region preferably comprises either oxidising a portion of the first surface of the silicon substrate, or etching at least one continuous groove, preferably an annular groove, in the first surface of the silicon substrate and thereafter forming silicon dioxide in the at least one groove.

The optical coupling may be provided by etching an aperture in the silicon dioxide region or, alternatively, by forming at least one projection comprising essentially of silicon dioxide on said silicon dioxide region. The projection may be formed by providing a layer of silicon over the silicon dioxide region; etching the layer of the silicon to form at least one structure projecting outwardly from said silicon dioxide region; and thereafter oxidising the at least one structure to form said at least one projection. Etching the layer of silicon may comprise etching at least two concentric grooves to form one or more annular projecting walls or, alternatively, etching two or more linear parallel grooves to form at least one planar projecting wall.

The step of providing an environmentally-sensitive element may comprise attaching a pressure-sensitive membrane having a radiation-reflective surface to the silicon dioxide region and etching a through-hole in the silicon dioxide region from the channel to the pressure-sensitive membrane. Alternatively, the environmentally-sensitive element may be provided by coating at least a portion of the at least one projection with luminescent material.

In a second aspect, the present invention provides a method of manufacturing a sensor comprising the steps of: providing a silicon wafer; forming at least one continuous groove in a first surface of the silicon wafer; applying or forming silicon dioxide in said continuous groove and over the surface area of the silicon wafer encompassed by the continuous groove to form a layer of silicon dioxide; applying a reflector over at least the layer of silicon dioxide encompassed by the continuous groove; forming a channel in the silicon wafer extending from an opposed second surface of the silicon wafer up to the layer of silicon dioxide and forming a cavity beyond the channel in which the wall of the cavity is defined by the silicon dioxide provided in the continuous groove, the longitudinal axis of the channel and the cavity substantially intersecting the centre of the path followed by the continuous groove; and removing at least the silicon dioxide layer encompassed by the continuous groove thereby exposing a reflective surface of said reflector.

The continuous groove in the silicon wafer may be in the form of a substantially circular groove provided by applying a mask having a ring aperture over the first surface of the silicon wafer and etching exposed regions of the first surface.

Preferably, a plurality of concentric continuous grooves are formed in the first surface of the silicon wafer, each concentric groove having a thickness and being separation from an adjacent groove a distance selected such that oxidation of the first surface of the silicon wafer including the plurality of concentric grooves produces a silicon dioxide torus in the first surface of the silicon wafer.

The reflector is preferably applied by coating at least the silicon dioxide layer encompassed by the continuous groove with a thin metallic film or thin film stack.

In a third aspect, the present invention provides a method of manufacturing a sensor comprising the steps of: providing a silicon-silicon dioxide-silicon wafer; etching an upper surface of the silicon-silicon dioxide-silicon wafer to form at least one silicon structure projecting from the silicon dioxide layer of the wafer, oxidising at least a portion of the exposed upper surface of the wafer including the silicon structure so as to form at least one silicon dioxide projection; coating at least a portion of the silicon dioxide projection with a luminescent material; and forming a channel in the opposed surface of the silicon-silicon dioxide-silicon wafer as far as the silicon dioxide layer, the longitudinal axis of the channel being substantially aligned with the silicon dioxide projection.

In a fourth aspect, the present invention provides a method of fabricating a plurality of optical sensors on a common substrate comprising the steps of: providing a silicon substrate having a first surface and a second surface; providing at least two regions each comprising essentially of silicon dioxide on or in the first surface of the silicon substrate; providing optical couplings each associated with a respective silicon dioxide region; providing at least one environmentally-sensitive element for optical coupling with a respective optical fibre by means of a respective one of the optical couplings; and etching at least one channel into the silicon substrate from said second surface up to one or more of said silicon dioxide regions, the channel being sized to receive an optical fibre whereby said one or more silicon dioxide region forms an end portion of the channel which at least partially closes said channel.

The step of etching at least one channel may comprise etching a plurality of channels, each channel being sized to receive an optical fibre and whereby each silicon dioxide region forms an end portion of the respective channel which at least partially closes said channel. Alternatively, the step of etching at least one channel may comprise etching a single channel into the silicon substrate from said second surface up to all said silicon dioxide regions, the channel being sized to receive an optical fibre whereby the silicon dioxide regions form an end portion of the channel which at least partially closes said channel.

The silicon substrate is preferably monolithic.

In a fifth aspect, the present invention provides an optical sensor comprising: a silicon substrate having a first surface and an opposed second surface; a channel extending into the silicon substrate from said second surface, said channel being sized to receive an optical fibre and having an end portion distant from said second surface, said end portion at least partially closing said channel and comprising essentially of silicon dioxide; and an optical coupling associated with said end portion of said channel.

The optical sensor preferably comprises an environmentally-sensitive element associated with the optical coupling.

The optical coupling of the sensor may comprise a through-hole in the end portion of the channel. In one particular embodiment, the environmentally-sensitive element is preferably a pressure-sensitive membrane provided at the first surface of the silicon substrate with the surface of the pressure-sensitive membrane facing towards the channel being reflective to incident radiation.

In an alternative embodiment, the optical coupling may comprise at least one projection consisting essentially of silicon dioxide provided on the end portion of the channel. In this embodiment, the environmentally-sensitive element is preferably a luminescent coating applied over at least a portion of the at least one projection.

In a sixth aspect, the present invention provides a sensor comprising a silicon wafer having a cavity in a first surface covered by a reflector and a channel extending from an opposed second surface of the silicon wafer to the cavity and being in communication therewith, the diameter of the channel being greater than the diameter of the cavity and the end of the channel adjacent the cavity comprising essentially of silicon dioxide.

The reflector is preferably a thin metallic film or a thin-film multi-layered dielectric stack.

In a seventh aspect, the present invention provides a sensor comprising a silicon wafer having at least a region of a first surface of the silicon wafer covered by a layer of silicon dioxide and at least one structure comprising essentially of silicon dioxide projecting outwardly from the silicon dioxide layer and having a luminescent material covering at least a portion of said silicon dioxide structure and a channel extending from an opposed second surface of the silicon wafer to said silicon dioxide layer and aligned with said silicon dioxide structure.

In an eighth aspect, the present invention provides a sensor system comprising a plurality of optical sensors on a common substrate having a first surface and an opposing second surface, each optical sensor comprising: a channel extending into the common substrate from said second surface, said channel being sized to receive an optical fibre and having an end portion distant from said second surface, said end portion at least partially closing said channel and comprising essentially of silicon dioxide; and an optical coupling associated with said end portion of said channel; at least one of said optical sensors further comprising an environmentally-sensitive element for optical coupling with an optical fibre by means of said optical coupling.

In a ninth aspect, the present invention provides a sensor system comprising a plurality of optical sensors on a common substrate having a first surface and an opposing second surface and a channel extending into the common substrate from said second surface, said channel being sized to receive an optical fibre, each optical sensor comprising: an end portion distant from said second surface at least partially closing said channel and comprising essentially of silicon dioxide; and an optical coupling associated with said end portion; at least one of said optical sensors further comprising an environmentally-sensitive element for optical coupling with an optical fibre by means of said optical coupling.

In a tenth aspect, the present invention provides a sensor system comprising a common substrate of monolithic silicon having a first surface and an opposing second surface and at least one pressure sensor and at least one optical sensor for measuring a parameter selected from, but not limited to, temperature, fluid flow, pH, oxygen concentration, carbon dioxide concentration, glucose concentration, lactate concentration, bicarbonate ion concentration, chlorine ion concentration, sodium and potassium ion concentration, the pressure sensor comprising: a cavity formed in the first surface of the substrate covered by a reflector and a channel extending from the second surface of the substrate to the cavity and being in communication therewith, the diameter of the channel being greater than the diameter of the cavity and the end of the channel adjacent the cavity comprising essentially of silicon dioxide; and the optical sensor comprising: a layer of silicon dioxide covering at least a region of the first surface of the substrate and at least one structure comprising essentially of silicon dioxide projecting outwardly from the silicon dioxide layer and having a luminescent material covering at least a portion of said silicon dioxide structure and a channel extending from the second surface of the substrate to said silicon dioxide layer and aligned with said silicon dioxide structure.

In an eleventh aspect, the present invention provides a method of securing an optical fibre to a silicon block, the method comprising the steps of: forming a channel extending into the silicon block from a surface of the block, the channel being sized so as to accommodate an end of the optical fibre; forming an aperture in the surface of the silicon block adjacent the opening of the channel in the surface of the silicon block; inserting an optical fibre into the channel; and applying an adhesive to the optical fibre and to the surface of the silicon block adjacent the optical fibre and including into the adjacent aperture.

The aperture is preferably an annular groove encircling the opening to the channel. Furthermore, the width of the aperture at the surface of the silicon block is preferably less than the width of the aperture below the surface of the silicon block

The sensors of the present invention are particularly well adapted for use in medicine applications where sensors having quick response times (sub-minute) can prove critical. With this invention sensors for monitoring blood pressure, temperature, fluid flow, pH, oxygen concentration, carbon dioxide concentration, glucose concentration, lactate concentration, bicarbonate ion concentration, chlorine ion concentration, sodium and potassium ion concentration, for example, can be provided on the end of a single probe. With the present invention sensor arrays having a sub-millimetre diameter can be fabricated which makes these sensors suitable for mounting on the end of in vivo probes such as endoscopes.

In particular, the sensors may be used in in vivo patient monitoring, such as that performed in intensive care units, elective surgery and anaesthetics. The sensors may also be used in conjunction with drug delivery systems arranged in feedback, such that drug delivery is controlled according to measurements made by the sensors. The sensors may also be used to assess particular medical conditions. For example, metabolic and hormone levels can be monitored using these sensors which is of use in assessing fertility levels.

The sensors may also be of use in the field of psychiatry by measuring, for example, the levels of neurotransmitters such as serotonin

The sensors of the present invention are also well adapted for use in food processing, for example, the sensors may be used to probe foodstuffs to measure temperature and/or pH levels.

As the sensors are preferably constructed from monolithic silicon, they can be manufactured using conventional techniques employed in MEMS manufacture. This makes the sensors suitable for mass production. Accordingly, disposable, sterile sensors having low production costs may be manufactured.

Embodiments of the present invention will now be described by way of example with reference to the accompanying drawings, in which:

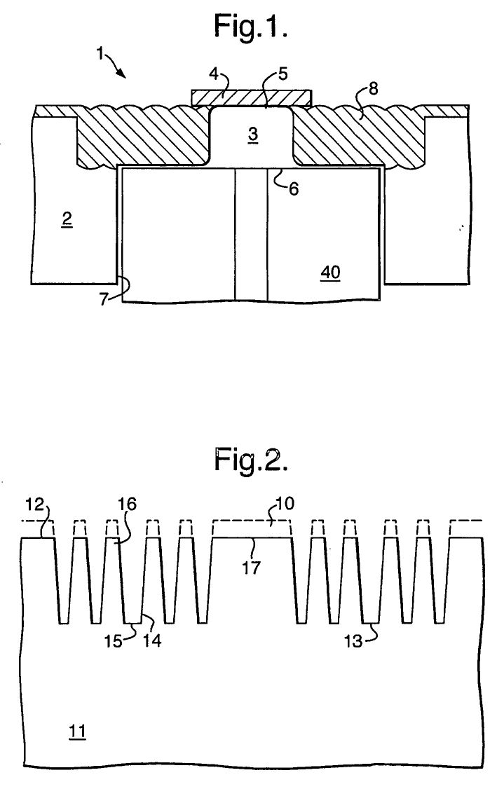

FIG. 1 is a schematic cross sectional view of a micro pressure sensor in accordance with a first embodiment of the present invention;

FIG. 2 illustrates a first step in the process of manufacturing the sensor of FIG. 1;

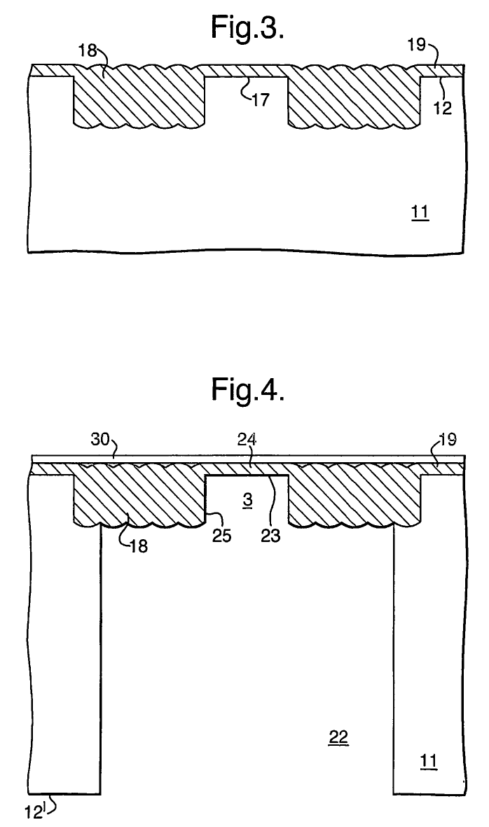

FIG. 3 illustrates a further step in the process of manufacturing the sensor of FIG. 1;

FIG. 4 illustrates a further step in the process of manufacturing the sensor of FIG. 1;

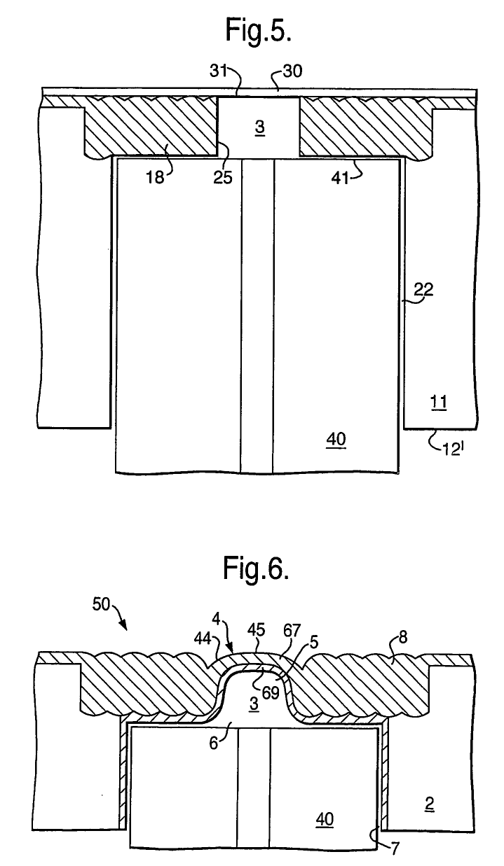

FIG. 5 illustrates a further step in the process of manufacturing the sensor of FIG. 1;

FIG. 6 is a schematic cross sectional view of a micro pressure sensor in accordance with a second embodiment the present invention;

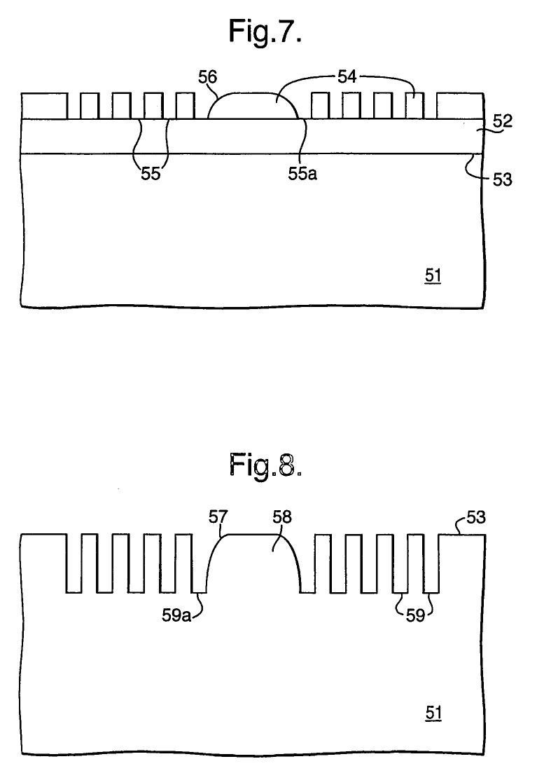

FIG. 7 illustrates a first step in the process of manufacturing the sensor of FIG. 6;

FIG. 8 illustrates a further step in the process of manufacturing the sensor of FIG. 6;

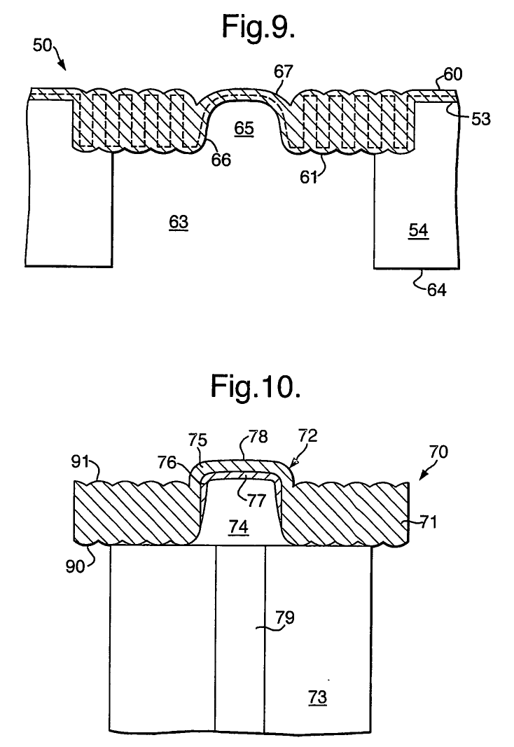

FIG. 9 illustrates a further step in the process of manufacturing the sensor of FIG. 6;

FIG. 10 is a schematic cross sectional view of a micro pressure sensor in accordance with a third embodiment the present invention;

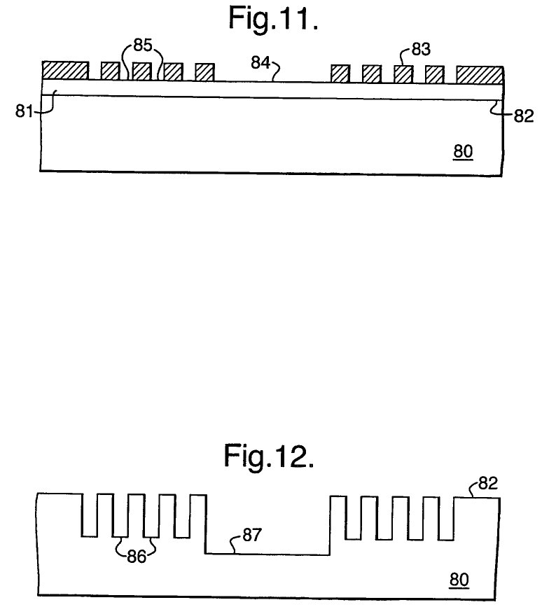

FIG. 11 illustrates a first step in the process of manufacturing the sensor of FIG. 10;

FIG. 12 illustrates a further step in the process of manufacturing the sensor of FIG. 10;

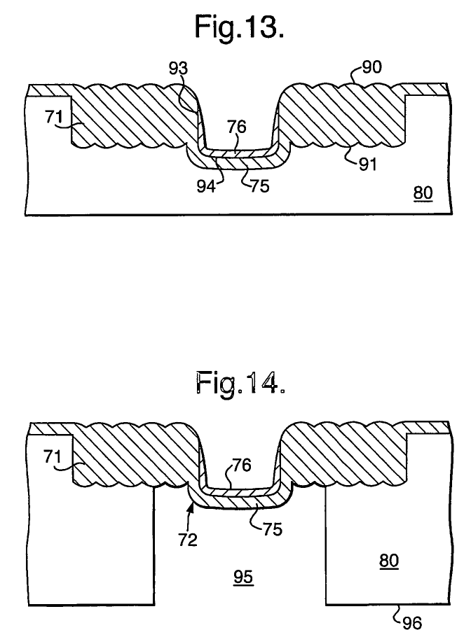

FIG. 13 illustrates a further step in the process of manufacturing the sensor of FIG. 10;

FIG. 14 illustrates an alternative step in the process of manufacturing the sensor of FIG. 10;

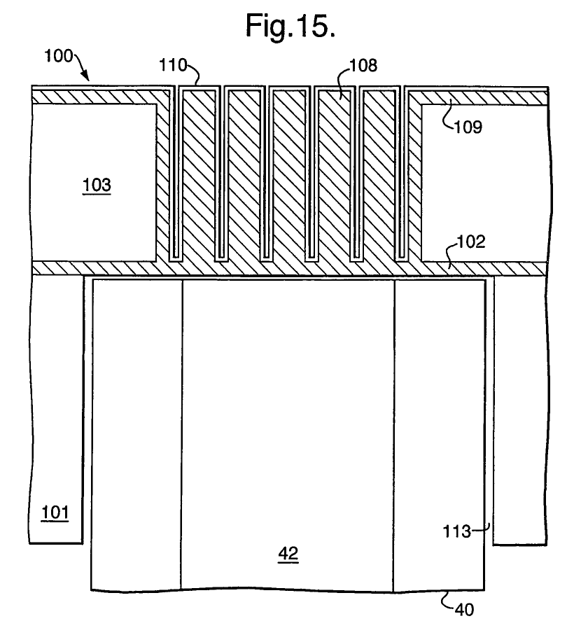

FIG. 15 is a schematic cross sectional view of a micro temperature sensor in accordance with a first embodiment of the present invention;

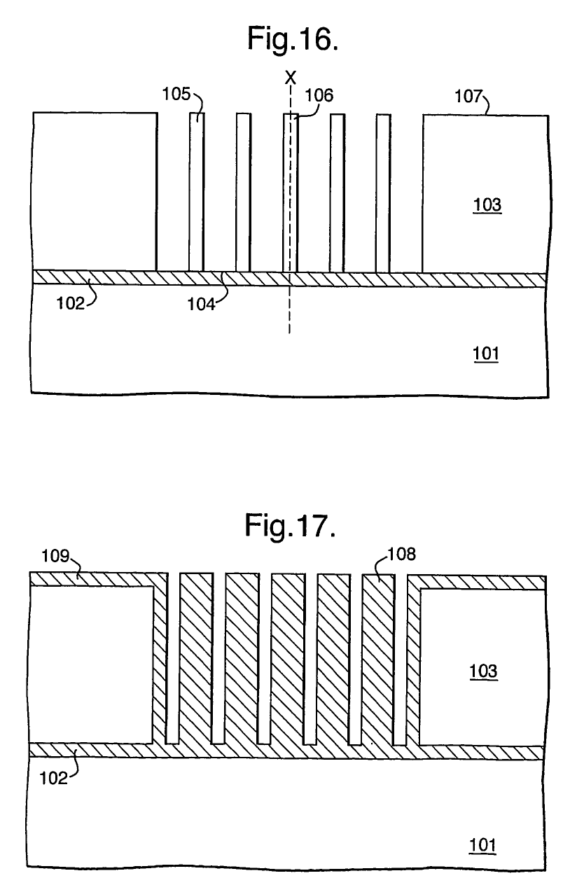

FIG. 16 illustrates a step in the process of manufacturing the sensor of FIG. 15;

FIG. 17 illustrates a further step in the process of manufacturing a sensor of FIG. 15;

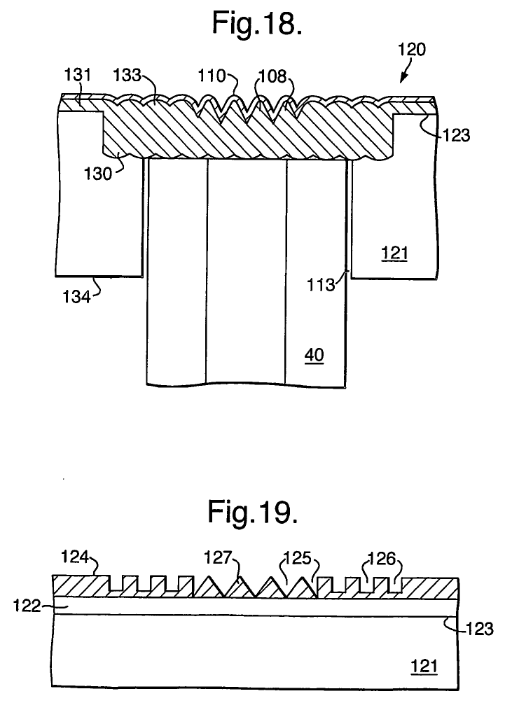

FIG. 18 is a schematic cross sectional view of a micro temperature sensor in accordance with a second embodiment of the present invention;

FIG. 19 illustrates a step in the process of manufacturing the sensor of FIG. 18;

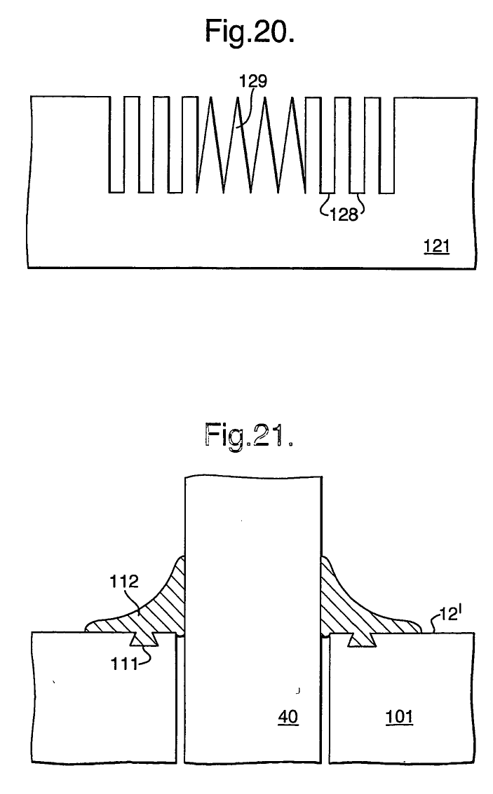

FIG. 20 illustrates a further step in the process of manufacturing a sensor of FIG. 18; and

FIG. 21 is a schematic cross sectional view of an annular groove formed on the surface of a substrate in accordance with present invention.

The micro sensor 1 illustrated in FIG. 1 is adapted to measure fluid pressure (gas or liquid, static or flowing) to which the sensor 1 is exposed. The sensor 1 is constructed from a silicon wafer and consists of a sensor body 2 having a Fabry-Perot cavity 3 and a membrane 4 disposed at a first end 5 of the cavity. The opposed second end 6 of the cavity 3 is in communication with a channel 7 adapted to receive an optical fibre. The sensor body 2 includes a shoulder 8 which encircles the second end 6 of the cavity 3 and which abuts and supports the end of the optical fibre inserted into the channel 7. In this example the sensor 1 has a cavity length of 30 μm and the channel 7 is sized to receive an optical fibre having an external diameter of 125 μm and a core diameter of 10 μm. It will be appreciated, however, that the sensor may be constructed with a different cavity length and be adapted to receiving other sizes of optical fibre.

As shown in FIG. 2, the first step of fabrication involves forming the supporting shoulder 8 of the sensor. With this particular fabrication method a series of concentric continuous grooves 13, for example annular grooves, are formed in a first (upper) surface 12 of a silicon substrate or wafer 11. Five concentric grooves 13 are illustrated having a collective inner and outer diameter of approximately 60 μm and 150 μm respectively. The profile of each groove 13 is approximately rectangular in cross-section with a depth of 30 μm and a radial width of approximately 5 μm Each groove 13 is separated from each neighbouring groove 13 by a radial distance of approximately 5 μm. Adjacent grooves 13 define a concentric ridge 16 with each concentric ridge 16 therebetween similarly having a generally rectangular profile with a height of 30 μm and a radial width of 5 μm.

The grooves 13 are formed by applying a photoresist mask 10 patterned with a series of concentric rings over the surface 12 of the silicon substrate 11 and etching the exposed surfaces using deep reactive ion etching (DRIE). Other masks, both soft and hard, may alternatively be used, e.g. silicon dioxide or silicon nitride. Whilst DRIE is the favoured method of etching due to its relatively high etch rates, alternative forms of etching, both wet and dry, may nevertheless be employed, e.g. photoenhanced wet chemical etching, KOH, sputter etching, vapour phase etching. Furthermore, it is not necessary that the etching process is anisotropic. Indeed, the cross-sectional profile of each groove 13 is preferably open such that an obtuse angle is formed by the sidewall 14 of each groove 13 and the base 15 of the groove 13. In having a groove with an open profile, the risk of starving the base 15 of the groove 13 of oxygen during the oxidation process (see below) is significantly reduced. A groove 13 having an open profile is achieved using DRIE by varying process parameters such as etchant and passivation gases, process pressures, switching ratios, coil and platen powers for a DRIE-type process. Alternatively, open profile grooves may be achieved by anisotropic wet etching of a single crystal of silicon, e g. photo-assisted and/or electrical-assisted wet chemical etching. The profile of each groove 13 is preferably such that the radial width at the base of each ridge 16 is 6 μm whilst the radial width at the top of each ridge 16 is 4 μm.

The photoresist mask 10 is then removed from the surface 12 of the silicon substrate 11 and the surface 12 is oxidised such that a layer of silicon dioxide 19 is formed over the upper surface of the silicon substrate and in particular over at least the grooved region of the silicon substrate and the region of the silicon substrate surface 17 located within, i.e. encompassed by the innermost concentric groove. The oxidation process is controlled such that only a 2 μm layer normal to the surface 12 of the silicon substrate 11 is oxidised. A silicon layer of thickness d will generally form a silicon dioxide layer of thickness 2.27 d upon oxidation. Accordingly, a silicon dioxide layer of approximately 4.55 μm in thickness is formed over at least the grooved regions and the region of the substrate 17 enclosed by the innermost concentric groove.

As is demonstrated in FIG. 3, the oxidation process results in a silicon substrate 11 having a single ring or torus 18 of silicon dioxide in its upper surface 12 which functions as a fibre supporting structure. The ring 18 generally has an inner diameter of 56 μm, an outer diameter of 154 μm and a depth of 34.55 μm. Also, over the top of the silicon substrate encompassed by the ring 18 lies a silicon dioxide layer 19 of around 4.5 μm in thickness. As the ring 18 in the surface 12 of the silicon substrate 11 was formed from the oxidation of the four concentric ridges 16 the silicon-silicon dioxide interface formed during oxidation may not be entirely planar along the base of the ring 18. Instead, the silicon-silicon dioxide interface may be rippled, as illustrated, with peaks of silicon immediately beneath where each of the former ridges was located. Similarly, the upper surface of the ring may have a corresponding ripple, as illustrated. In the Figures, the rippling is exaggerated for ease of identification.

Wet thermal oxidation is the preferred method of oxidation as it encourages fusion of the concentric ridges 16. In addition, the rates of oxidation that can be achieved are relatively fast. Whilst other forms of oxidation, such as wet anodisation, chemical vapour deposition or plasma oxidation, may alternatively be employed, the concentric ridges 16 do not fuse and the ring 18 is thus less strong. It is important that the oxidised ring 18 has a high etch selectivity to silicon when exposed to DRIE such that it provides an etch stop. Nevertheless, alternative forms of oxidation may be employed in addition to wet thermal oxidation to fill any exposed voids in the oxide ring 18.

Turning now to FIG. 4, after oxidation, a reflector layer in the form of a metallic thin film 30 is deposited over at least the surface of the silicon dioxide layer 19 enclosed by the silicon dioxide ring 18. The metallic thin film is preferably aluminium or copper and is preferably of a few hundred Angstroms thick. The film may be deposited using conventional deposition techniques, e.g. sputtering or chemical vapour deposition. The choice of metal and thickness of the film will depend upon the desired pressure range and sensitivity of the sensor. The choice of metal may also be dictated to some extent by the wavelength characteristics of the radiation that will be reflected from the surface of the film. Whilst reference herein has been to a metallic thin film for reflecting the incident radiation, alternative materials such as multilayer dielectric stacks or dichroic dielectric materials may similarly be used as the reflecting material. Again, conventional methods may be employed for applying these materials over the silicon dioxide layer 19.

Following application of the reflector layer 30, a channel 22 is etched into the opposed second surface 12′ of the silicon substrate 11. The channel 22 is generally cylindrical in shape and has a diameter sufficient to receive an optical fibre. The channel 22 extends into the silicon substrate 11 as far as the layer 19 of silicon dioxide. Thus, the silicon dioxide layer is used as the etch stop and produces a channel the end of which comprises essentially of the silicon dioxide. The end of the channel is only partially closed so that it may communicate with a cavity 3 defined by the internal diameter of the silicon dioxide ring 18 and the section 24 of the silicon dioxide layer encompassed by the ring 18. The longitudinal axis of the channel 22 is substantially normal to the innermost surface 23 of the silicon dioxide disc 24 enclosed by the innermost wall 25 of the ring 18. Furthermore, preferably the intersection of the longitudinal axis of the channel 22 with the silicon dioxide surface 23 is substantially coincident with the centre of the innermost wall 25 of the ring 18. As a result of the diameter of the channel 22, which is preferably 126-130 μm in order to accommodate the optical fibre, and the diameter of the cavity 3, a portion of the ring 18 is exposed as a result of the etch and acts as an annular shoulder at the inner end of the channel 22 for abutment with an end of the optical fibre when inserted 25 into the channel 22. In this way the end of the optical fibre forms the final, closing, wall of the cavity 3.

The channel 22 is preferably formed using DRIE owing to the relatively high etch rates and the ability to achieve almost vertical sidewalls. Again, alternative forms of anisotropic etching may be employed.

To aid assembly of the sensor, the opening of the channel at the second surface 12′ of the silicon substrate is tapered so as to assist fibre alignment. Tapering of the channel is achieved by first carving out an isotropic reactive ion etch on the opposed second surface 12′ of the silicon substrate 11 followed by an anisotropic deep reactive ion etch.

Finally, as illustrated in FIG. 5, the exposed silicon dioxide at the inner end of the channel 22 and in the cavity 3 is etched using conventional etching processes until the surface of the reflector 30 is exposed. Preferably, the entire silicon dioxide disc 24 enclosed by the innermost wall 25 of the ring 18 is removed. However, in some instances it may be desirable to remove only a portion of the silicon dioxide disc 24.

The channel 22 thus extends from an open second end 12′ of the silicon substrate 11, through the substrate to a cavity and to a closed cavity end formed by the innermost surface of the reflector 30. Within the channel 22 is an annular shoulder formed by an exposed portion of the silicon dioxide ring 18. The distance between the fibre abutting surface of the annular shoulder and the innermost surface of the reflector 30, along the longitudinal axis of the channel 22 is the cavity length which, with this fabrication method, is accurately fabricated to 30 μm or whatever cavity length is required.

In the final construction of the pressure sensor, with reference to FIG. 5, an optical fibre 40 is inserted into the sensor 10 via the open end of the channel 22 and pushed along the channel 22 until the end of the fibre 41 abuts the annular shoulder 18. At this point, the end 41 of the optical fibre 40, the innermost annular wall 25 of the ring 18 and the innermost surface 31 of the reflector 30 form a Fabry-Perot cavity. The cavity length is defined by the distance between the end surface 41 of the optical fibre 40 and the innermost surface 31 of the reflector 30, parallel to the longitudinal axis of the optical fibre.

In the above-described example, the initial concentric grooves 13 formed in the silicon substrate 11 were chosen to have a collective inner and outer diameter of 60 μm and 150 μm respectively. The diameter of the innermost groove, along with the degree of oxidation of the silicon surface 12, ultimately determines the maximum exposed area of the pressure-sensitive membrane formed by the reflector 30. An innermost groove having a larger diameter will enable a pressure membrane of larger surface area to be formed. Accordingly, the sensitivity of the pressure sensor 10 may be increased. Conversely, an innermost groove having a smaller diameter will enable a pressure membrane of smaller surface area to be formed, resulting in a less sensitive pressure sensor 10. Of course, the diameter of the innermost groove must not exceed the external diameter of the optical fibre 40. Thus, the diameter of the innermost concentric groove is required to be less than the external diameter of the optical fibre 40 and is ideally greater than the core diameter of the optical fibre 40 so that all of the light transmitted by the core is coupled to the cavity.

Furthermore, the diameter of the outermost groove is preferably greater than the external diameter of the optical fibre 40. This makes the task of forming the channel 22 in the silicon substrate 11 relatively simple as an area of the substrate 11, having a diameter at least that of the external diameter of the optic fibre 40 can be etched for a period of time known to be sufficient or more than sufficient for etching the full depth of the substrate 11. However, where the external diameter of the optical fibre 40 is greater than the outer diameter of the ring 18 the channel etching process would only result in the base of the silicon dioxide ring being exposed on all three surfaces. Also, although not illustrated it is envisaged that subsequent finishing processes including but not limited to coating the etched surfaces of the silicon dioxide ring within the channel are envisaged.

The degree of oxidation is chosen such that a layer of around 4-5 μm of silicon dioxide is formed over the silicon wafer. This layer 19 of silicon dioxide supports the reflector 30 during the subsequent fabrication steps. Thicker or thinner layers 19 of silicon dioxide may of course be employed as desired.

Naturally, the width and separation of the silicon ridges 16 may be tailored to suit. However, care should be taken to ensure that the base of the trough 18 of the silicon substrate 11 is not staved of oxygen during the oxidation process. Alternatively, rather than forming a series of concentric grooves 15, a single continuous trough, having the same inner and outer diameter may be formed in the surtace of the silicon substrate 11 which is subsequently filled by coating the trough, for example, with spin-on-glass or sol gel, for example, to form the fibre supporting ring 18. Multiple coatings may be required to fill the etched trough. With this fabrication process a signature depression around the ring would be formed on backing the fluid.

It will, of course, be appreciated that the depth of the grooves 15 or single trough formed in the silicon substrate 11 depends upon the desired cavity length and the degree of oxidation (or thickness of the spin-on-glass) employed. Naturally, the depth of the grooves 15 or single trough and the degree of oxidation is adjusted according to the desired cavity length.

The micro sensor 50 illustrated in FIG. 6 is an alternative design of pressure sensor having many of the features of the sensor 1 illustrated in FIG. 1. In particular, the sensor 50 is constructed from a silicon substrate and consists of a sensor body 2 having a Fabry-Perot cavity 3 and a membrane 4 disposed at a first end 5 of the cavity 3. The opposed second end 6 of the cavity 3 is in communication with a channel 7 adapted to receive an optical fibre 40. The sensor body 2 includes a shoulder 8 which encircles the second end 6 of the cavity 3 and which abuts and supports the end of the optical fibre 40 inserted into the channel 7. Unlike the sensor 1 illustrated in FIG. 1, the pressure membrane 4 comprises a thin reflective film 69 disposed over a silicon dioxide member 67. The silicon dioxide member 67 comprises a substantially planar portion 45 and a perimeter wall 44 surrounding the planar portion 45. The perimeter wall 44 is preferably curved to hamper the occurrence of cracks and other stress features that might otherwise arise due to high stress concentrations at a sharp comer, e.g. had the perimeter wall 44 met the planar portion at right-angle.

As shown in FIG. 7, the pressure sensor 50 illustrated in FIG. 6 is fabricated from a silicon substrate 51, such as a silicon wafer, provided with a layer of silicon dioxide 52 on an upper surface 53. The silicon dioxide layer 52 may be formed on the silicon substrate 51 by conventional means, but is preferably formed by plasma enhanced chemical vapour deposition (PECVD) or thermal oxidation of the silicon substrate 51 which results in chemical bonding between the silicon substrate 51 and the silicon dioxide layer 52. The silicon dioxide layer 52 must be thick enough to act as a mask when subsequently etching the silicon substrate 51. However, as the thickness of the silicon dioxide layer 52 increases the time taken to form the silicon dioxide layer 51 also increases. Accordingly, the silicon dioxide layer is preferably not much thicker than that required for subsequent etching of the silicon substrate 51. For the depth of etching that is contemplated in the present example, a silicon dioxide layer 51 of around 10 μm is suitable.

The exposed upper surface of the silicon dioxide layer 52 is covered with a photoresist mask 54 that is lithographically patterned with a series of concentric grooves 55 similar to those formed in the mask 10 described above and illustrated in FIG. 2. The photoresist mask 54 is preferably a greyscale mask patterned such that the innermost wall 56 of the innermost groove 55a is preferably curved so as to create a curved perimeter wall 44 in the resulting silicon dioxide member 67.

The structure of the photoresist mask 54 is transferred to the silicon dioxide layer 52 by reactive ion etching, and the structure of the silicon dioxide layer 52 is subsequently transferred to the upper surface 53 of the silicon substrate 51 by deep reactive ion etching to result in the structure as shown in FIG. 8. The grooves 59 formed in the silicon substrate 51 are again similar to those described above and illustrated in FIG. 2. Indeed, the only significant difference between the silicon substrate 54 illustrated in FIG. 8 and that illustrated in FIG. 2 is the presence of a curved inner wall 57 for the innermost concentric groove 59a.

Any passivation layer deposited on the silicon substrate 54 during the deep reactive ion etch is removed and the exposed upper surface 53 of the silicon substrate is oxidised in a manner similar to that described above and illustrated in FIG. 3. As shown in FIG. 9, the oxidation process results in a single ring or torus 61 of silicon dioxide which functions as a fibre supporting structure for the sensor 50. In addition, a layer of silicon dioxide 60 is formed over the top surface of the silicon substrate 54. As in the fabrication of the sensor illustrated in FIG. 1, the silicon-silicon dioxide interface may not be entirely planar along the base of the ring 61 but may instead be rippled Similarly, the upper surface of the ring 61 may have a corresponding ripple. Again, the rippling is exaggerated in FIGS. 6 and 9 for ease of identification.

Following oxidation, a channel 63 generally cylindrical in shape and having a diameter sufficient to receive an optical fibre is etched, preferably by DRIE, into the opposed second surface 64 of the silicon substrate 54. The channel 63 extends into the silicon substrate 54 as far as the silicon dioxide ring 61 which acts as an etch stop. Etching continues to create a cavity 65 that is in communication with the channel 63 and is defined by the innermost wall 66 of the silicon dioxide ring 61 and the region 67 of silicon dioxide layer 60 encompassed by the ring 61. The longitudinal axis of the channel 60 is substantially normal to the inner surface of the silicon dioxide region 67 encompassed by the ring 61. The diameter of the channel 63 is preferably no greater than the outermost diameter of the silicon dioxide ring 61.

After the channel 63 and cavity 65 have been formed, a thin reflective film 69 is deposited over at least the inner surface 65 of the silicon dioxide member 67 enclosed by the silicon dioxide ring 61. The film 69 may be deposited using conventional deposition techniques, e.g. physical or chemical vapour deposition. The reflective film 69 is preferably metallic, such as aluminium or copper, having a thickness of a few hundred Angstroms. However, as noted above for the pressure sensor illustrated in FIG. 1, the choice of material and thickness of the film will depend upon the desired pressure range and sensitivity of the sensor, as well as the choice of illuminating radiation. In particular, the film 69 may alternatively comprise a multilayer dielectric stack or a dichroic dielectric.

FIG. 10 illustrates a third embodiment of a pressure sensor 70. The sensor 70 comprises a ring or torus 71 of silicon dioxide and a pressure membrane 72 covering the opening at a first end of the ring 71. An optical fibre 73 is secured, by an adhesive or solder, to the ring 71 so as to cover the opening at the second opposed end of the ring 71 and thereby define a Fabry-Perot cavity 74. The pressure membrane 72 comprises a layer of silicon dioxide 75 and a thin reflective film 76.

The reflective film 76 is preferably disposed on that surface 77 of the layer of silicon dioxide 75 adjacent the Fabry-Perot cavity 74, but may alternatively be disposed over that surface 78 remote from the cavity 74. As in the case of the pressure sensors 1, 50 described above and illustrated in FIG. 1 and 6, the reflective film 76 is preferably metallic, such as aluminium or copper, having a thickness of a few hundred Angstroms. Alternative materials, such as a multilayer dielectric stack or a dichroic dielectric, may however be used according to the desired pressure range, sensitivity of the sensor and choice of illuminating radiation.

The inner diameter of the ring 71 is preferably greater than the diameter of the core 79 of the optical fibre 73 so that all of the light transmitted by the optical fibre is coupled to the cavity 74.

As shown in FIG. 11, the pressure sensor 70 is fabricated from a silicon substrate 80, such as a silicon wafer, provided with a layer of silicon dioxide 81 on an upper surface 82. As described above in the manufacture of the sensor 50 illustrated in FIG. 6, the silicon dioxide layer 81 may be formed on the silicon substrate 80 by conventional means, and is preferably formed by PECVD or thermal oxidation of the silicon substrate 80. As before, a silicon dioxide layer 81 of around 10 μm thick is suitable.

The exposed upper surface of the silicon dioxide layer 81 is covered with a photoresist mask 83 that is lithographically patterned with a central circular hollow 84 and a series of concentric grooves 85 having profiles and dimensions similar to those formed in the mask 10 described above and illustrated in FIG. 2.

The structure of the photoresist mask 83 is transferred to the silicon dioxide layer 81 by reactive ion etching, and the structure of the silicon dioxide layer 81 is subsequently transferred to the upper surface 82 of the silicon substrate 80 by deep reactive ion etching to result in the structure illustrated in FIG. 12. The grooves 86 formed in the silicon substrate 80 have similar profiles and dimensions to those grooves 13 formed in silicon substrate 11 of the pressure sensor 1 described above and illustrated in FIG. 2. The silicon substrate 80 is preferably etched such that the central depression 87 has a depth that is greater than that of the grooves 86. Nevertheless, the depression 87 may alternatively have the same or smaller depth than that of the grooves 86. The depression 87 should, however, be deep enough to ensure that the pressure membrane 72 formed subsequently does not project beyond the top surface 90 of the silicon dioxide ring 71. As is further discussed below, the central depression 87 ultimately defines the shape and size of the pressure membrane 72 of the sensor 80. The sensitivity of the pressure membrane 72 may therefore be adjusted by varying the shape and size of the central depression 87. In particular, by increasing the diameter of the central depression 87 the sensitivity of the pressure membrane may be increased. Preferably, the diameter of the central depression 87 is greater than the diameter of the core 79 of the optical fibre 73, but less than the outer diameter of the fibre 73, with which the sensor 80 is intended to be used.

Any passivation layer deposited on the silicon substrate 80 during the deep reactive ion etch is removed and the upper surface of the silicon substrate is oxidised in a manner similar to that described above and illustrated in FIG. 3. As illustrated in FIG. 13, the oxidation process results in a single ring or torus 71 of silicon dioxide which functions as a fibre supporting structure for the sensor 70. In addition, a layer of silicon dioxide 75 is formed over the top of the depression in the silicon substrate 80. This circular disc 75 of silicon dioxide is bonded to and is integral with the base of the ring 71. Again, as already noted above, the top 90 and bottom 91 surfaces of the silicon dioxide ring 71 may not be entirely planar but may instead be rippled.

The circular disc 75 of silicon dioxide forms part of the pressure membrane 72 of the sensor 70. As already noted, the size and shape of the disc 75 will affect the sensitivity of the pressure membrane 72. Additionally, the thickness of the disc 75 will also affect the sensitivity of the membrane 72. After oxidation, the upper exposed surfaces of silicon dioxide are etched using reactive ion etching until the disc 75 has a desired thickness.

A thin reflective film 76 is subsequently deposited over all exposed silicon dioxide surfaces using conventional deposition techniques such as physical or chemical vapour deposition. As noted above, the reflective film 76 is preferably metallic, such as aluminium or copper, having a thickness of a few hundred Angstroms, but alternative materials, such as a multilayer dielectric stack or a dichroic dielectric, may also be used.

The thin reflective film 76 is then selectively etched from all silicon dioxide surfaces with the exception of the inner wall 93 of the silicon dioxide ring 71 and the upper exposed surface 94 of the silicon dioxide disc 75.

An optical fibre 73 is then secured to the upper exposed surface 90 of the silicon dioxide ring 71 such that the core 79 of the fibre 73 is optically coupled with the cavity 74 that is created between the optical fibre 73 and the thin reflective film 76 disposed over the silicon dioxide disc 75. The fibre 73 is secured to the ring 71 by conventional means such as epoxy, or metal or glass soldering.

Finally, the silicon substrate 80 is removed using KOH or similar etchant to leave the fibre 73 and sensor 70 as depicted in FIG. 10. Alternatively, rather than removing the entire silicon substrate 80, a channel 95 may be etched back in the lower surface 96 of the silicon substrate 80, as shown in FIG. 14. The channel 95 is of sufficient size and shape to ensure that the entire pressure membrane 72 is exposed. The channel is preferably formed prior to the step of securing the optical fibre 73 to the silicon dioxide ring 71 and may be etched using conventional etching methods and preferably DRIE.

Whilst in the embodiment described above, the reflective film 76 is deposited over that surface of the disc 75 adjacent the Fabry-Perot cavity 74, the reflective film 76 may alternatively be deposited over that surface of the disc 71 remote from the cavity 74. For example, after the channel 95 has been etched, the silicon dioxide exposed by the channel 95 may be etched by RIE to achieve a desired thickness of disc 75. The thin reflective film 76 may then be deposited over that surface of disc 75 exposed by the channel 95.The micro sensor 100 illustrated in FIG. 15 is an alternative sensor adapted to measure the environmental temperature to which the sensor 100 is exposed. The sensor 100 is constructed from a silicon-on-insulator (SOI) wafer and consists of a sensor body having a channel 113 for receiving an optical fibre 40. With the optical fibre 40 in position within the channel 113, the optical fibre 40 is optically coupled by means of a silicon dioxide layer 102 to a series of silicon dioxide ridges 108. The silicon dioxide ridges 108 are coated with a luminescent material 110 the emission characteristics of which are temperature dependent. In this example, the sensor 100 is adapted to receive an optical fibre having an external diameter of 200 μm and a core diameter of 80 μm. As with the previous example, it will be appreciated that the fabrication steps described herein, similar to those described above, may be employed to manufacture a sensor adapted to receive any size of optical fibre.

FIGS. 16 and 17 illustrate the steps employed in fabricating the temperature sensor. With this method a sensor is fabricated which is adapted to luminesce in response to incident radiation delivered via an optical fibre. The luminescent radiation can then be used to determine environmental conditions to which the sensor is exposed, such as temperature, fluid flow, pH, oxygen concentration, carbon dioxide concentration, glucose concentration, lactate concentration, bicarbonate ion concentration, chlorine ion concentration, sodium and potassium ion concentration, etc.

As shown in FIG. 16, the sensor is manufactured from SOI i.e. a silicon substrate 101 having a first layer of silicon dioxide 102 and a second uppermost layer of silicon 103 disposed thereon. The silicon dioxide layer 102 is typically achieved by fusion bonding two oxide coated silicon wafers. The uppermost layer of silicon 103 is approximately 300 μm thick, whilst the layer of silicon dioxide 102 is approximately 2 μm thick.

Concentric continuous grooves are formed on the surface 107 of the silicon layer 103 about a common central axis X (three grooves are illustrated). The grooves extend the entire depth of the silicon layer 103 such that regions 104 of the silicon dioxide layer 102 are revealed at the base of each groove. The sidewalls of each groove are substantially straight and each groove has a radial width of around 10 μm and is separated from each neighbouring groove by a radial distance of approximately 5 μm. Concentric ridges 105 of silicon are formed between each pair of neighbouring grooves, each concentric ridge 105 having a generally rectangular profile with a height of 300 μm and a radial width of 5 μm. A central column 106 is also formed having a diameter of 5 μm.

The grooves are formed by applying a photoresist mask (not illustrated) over the surface 107 of the silicon layer 103 and etching the exposed surfaces using deep reactive ion etching (DRIE). The silicon dioxide layer 102 acts as the etch stop. As in the previous embodiment, other masks and etching techniques may be employed to form the concentric grooves.

Once the grooves have been formed, the etch maask is removed and the silicon layer 103 is subjected to oxidation. The oxidation process is maintained until all the silicon in the concentric silicon ridges 105 has been oxidised. Preferably, wet thermal oxidation is employed owing to the high degree of oxidation that is achieved as well as the relatively fast rates of oxidation. Alternative forms of oxidation, such as wet anodisation, chemical vapour deposition or plasma oxidation, may be employed. However, their use would depend upon the wavelength of the emitted radiation. For example, for longer wavelengths, i.e. infra red, silicon could act as the core of the waveguide. Additionally, DRIE could produce waveguide structures in glass wafers anodically bonded to a silicon substrate.

The resulting structure, as shown in FIG. 17, comprises a silicon substrate 101 having a layer of silicon dioxide 102 disposed thereon with a plurality (two are illustrated) of concentric silicon dioxide ridges 108 extending substantially normal to the layer of silicon 101 and a central column 106. On top of the silicon dioxide layer 102, to the outside of the outermost concentric ridge 108, a further layer of silicon 103 is provided which has as layer of silicon dioxide 109 on what would otherwise be exposed surfaces of the silicon. To maximise the exposed surface area of the ridges 108, the separation of the individual ridges of silicon 105 must be sufficient to prevent occlusion during the oxidation stage.

The silicon dioxide ridges 108 are thereafter coated with a luminescent material 110 (FIG. 15). The choice of luminescent material and the thickness of the coating 110 will depend upon (a) the environmental parameter to be measured (b) the method by which the parameter is to be measured and (c) the incident radiation used for excitation. The luminescent coating 110 is preferably applied as a thin film so as to maximise the sensitivity and response of the coating 110 to changes in the environmental parameter to be measured. Accordingly, the luminescent material is preferably applied using chemical vapour deposition. However, alternative forms of deposition may also be used, e.g. thermal evaporation, electron beam evaporation, sputtering, ink-jet, electrospraying, sol gel techniques etc. To optimise performance laser annealing and thermal annealing may be used to incorporate the luminescent ions in the host lattice of the luminescent material.

Depending upon the luminescent material used, changes in an environmental parameter may cause any of the following to occur: (1) a change in the peak intensity of the luminescent radiation, (2) a shift in the wavelength of the luminescent radiation, (3) a change in decay times of the luminescent radiation. Examples of luminescent materials suitable for measuring a whole range of environmental parameters can be found, for example, in “Ruthenium complex entrapped in a porous sol gel film”, A. K. McEvoy et al, SPIE, vol.2508, pp 190-198; “The Oxylite: A fibre-optic oxygen sensor”, J. R. Griffiths et al., Brit. J. Radiology, vol. 72, pp 627-630, 1999; “Development of a Medical Fiber-Optic Oxygen Sensor Based on Optical Absorption Change”, R. A. Wolthuis et al., IEEE Trans Biomed. Eng., vol. 39, pp 185-193, 1992; “Fiber-optic oxygen sensor using molybdenum chloride cluster luminescence”, R. N. Ghosh et al., App. Phys. Lett., vol. 75, pp 2885-2887, 1999; “Sol gel based fiber optic pH sensor”, S. A. Grant et al., SPIE, vol. 2976, pp 64-70; “Wide Range pH Fiber Sensor with Congo-Red and Methyl-Red Doped Poly (Methyl Methacrylate) Cladding”, Egami et al., Jap. J. App. Phys., vol.36, pp-2902-2905, 1997; “Gastric pH sensing with CPGs fixed at the distal end of plastic optical fibres”, F. Baldini et al., SPIE, vol.2293, pp 149-153; “Absorbance-based affinity glucose sensor”, S. Mansouri et al., Optical Fibers in Medicine, SPIE, vol. 906, pp 57-59, 1988; “Advances in fibre-optic sensors for in-vivo monitoring”, F. Baldini et al., SPIE, vol. 2508, pp 117-135; “Ion-selective sensing based on potential sensitive dyes”, Z. Zhujun et al., Optical Fibers in Medicine III, SPIE, vol. 906, pp. 74-79, 1988.

Preferably the luminescent coating 110 is then annealed to improve its performance. UV laser annealing is preferred owing to its ability to deliver high temperatures (ca. 1800 K) into an absorbing surface up to 1 μm in thickness. Alternatively, the sensor may be globally annealed, say at 1000 K, over a period of several hours. When global annealing is employed, the sensor may be annealed in an oxygen rich atmosphere to further improve the performance of luminescent coatings having oxide-based host lattices, e.g. yttrium oxide.

Following annealing, a channel 113 is formed in the opposed second surface of the silicon substrate 101. The channel 113 is generally cylindrical in shape and has a diameter sufficient to accommodate an optical fibre. The channel 113 extends the entire length of the silicon substrate 101 and terminates at the silicon dioxide layer 102. The longitudinal axis of the channel 113 is generally parallel and coincident with the longitudinal axis X of the concentric ridges 108. Preferably the maxinum diameter of the ridges 108 is less than the outer diameter of the optical fibre such that a peripheral supporting structure in the form of the silicon dioxide layer 102 and the upper silicon layer 103 is provided to support the edges of the optical fibre.

The channel 113 is preferably formed using DRIE owing to the relatively high etch rates and the ability to achieve substantially vertical sidewalls. Similar to the previous example, the silicon dioxide layer 102 acts as the etch stop. Alternative forms of isotropic etching may nevertheless be employed.

With reference to FIG. 15, it can be seen that good optical coupling can be achieved between the core 42 of the optical fibre 40 and the luminescent material 110 via the silicon dioxide layer 102 and ridges 108 which acts as an optical coupling between the optical fibre and the luminescent material 110. The ridges 108 serve to collect the luminescence radiation and channel it towards the optical fibre 40. Furthermore, by using ridges 108 the area of luminescent material 110 is maximised to increase the signal intensity.

The wavelength of the incident radiation may be chosen so as to increase the amount of collected radiation emitted by the luminescent material 110. For example, incident radiation of wavelength X may cause the luminescent material 110 to emit radiation of wavelength Y. The refractive index of the luminescent material 110 and the silicon dioxide ridges 108 at wavelength Y might be 1.3 and 1.445 respectively. This corresponds to a cone of half angle of 64°. Accordingly, any light emitted by the luminescent material 110 which meets the silicon dioxide interface at an angle within this cone will pass through the silicon dioxide ridges 108 due to critical angle considerations. This corresponds to roughly 70% of the emitted radiation being lost. If, however, the incident radiation is chosen such that emitted radiation has a different wavelength, and the refractive index of the luminescent material 110 at this wavelength is much lower, say approaching 1, then the cone of half angle is reduced to 43°. Accordingly, less of the radiation emitted by the luminescent material 110 is lost. Alternatively, an increase in the amount of collected luminescent radiation may be achieved by employing luminescent materials 110 having a low index of refraction for the wavelength emitted, or where there is a large step in the indices of refraction for the luminescent material 1 10 and silicon dioxide ridges 108 at the emitted wavelength.

Before the silicon dioxide ridges 108 are coated with luminescent material, the ridges may first be coated with a cladding material, for example MgF₂, doped or porous silica or some other dielectric, which serves to protect the silicon dioxide ridges. Moreover, a cladding material having a refractive index between that of the silicon dioxide ridges and the luminescent material would aid in channelling the luminescent radiation along the ridges towards to the optical fibre, i.e. the cladding would act as an antireflective coating for the radiation emitted by the luminescent material. The cladding layer may be applied using conventional deposition techniques, e.g. sputter, chemical vapour deposition (PECVD or LPCVD) or evaporation.

Although in the above example silicon dioxide ridges 108 in the form of concentric rings are described, other structures are possible whilst greatly increasing the available surface area. For example, rather than forming a series of concentric grooves in the surface 107 of the silicon layer 103, a series of parallel, linear grooves may alternatively be formed. This would then result in a series of planar ridges upon which to deposit the luminescent material. A further alternative that is envisaged is a plurality of freestanding cylindrical columns, arranged for example in a hexagonal array. Where the luminescent material is applied as an ink, or other liquid, freestanding columns encourages flow of the material about and between the silicon dioxide ridges. It will be appreciated that the number, shape and size of the silicon dioxide structures may be tailored to suit. Moreover, the surface area of the structures may be increased by increasing the thickness of the silicon layer 103.

The grooves formed on surface 107 of the silicon layer 103 preferably have an open profile such that an obtuse angle is formed by the sidewalls and the base of each groove. In having a groove with an open profile, the oxide ridges 108 may promote waveguiding for luminescent materials having a lower refractive index than that of the ridges 108.

Owing to the relatively high surface area of the luminescent coating and the high optical coupling between the optical fibre and the luminescent coating, sufficient luminescent intensity can be collected even from thin luminescent coatings. Accordingly, sensors having a quick response time (sub-minute) are possible. In addition, luminescent materials having a fast decay time may be used. Generally, fast decay times are only possible at the expense of luminescent intensity. Sensors having a shorter dead time may therefore be formed.

FIG. 18 illustrates an alternative design of luminescent sensor 120 manufactured from a silicon rather than SOI wafer. As with the sensor 100 described above and illustrated in FIG. 15, the sensor 120 comprises a sensor body 121 having a channel 113 for receiving an optical fibre 40. With the optical fibre 40 in position within the channel 113, the optical fibre 40 is optically coupled to a series of silicon dioxide ridges 108, which are coated with a luminescent material 110.

The ridges 108 are preferably tapered so as to yield a high absorption cross-section per unit length. For ridges 108 having a generally rectangular profile, the absorption of the incident radiation by the luminescent material 110 is not uniform along the length of the ridge 108 but is generally exponential. Accordingly, only a small length of luminescent material 110 is effectively used. The profiles of the ridges 108 are therefore preferably tapered. Moreover, the profile is preferably parabolic, polynomial or exponential so as to achieve a quasi-linear absorption coefficient along the length of the ridges 108.

Each silicon dioxide ridge 108 preferably has a width at its base of between 2 and 10 μm, tapering to a width at its tip of between 0.2 and 5 μm, and a height of up to 500 μm. In having silicon dioxide ridges 108 of a width comparable, or indeed smaller, than the wavelength of incident radiation, good optical coupling is achieved with the luminescent material 110 surrounding the ridges 108. Nevertheless, it will be understood that alternative dimensions for the ridges 108 may be employed to suit.

The height of each ridge 108 may be longer than necessary so as to account for process tolerances, though this may result in some reduction in sensitivity. For example, the height of a ridge 108 having a width at its base of 10 μm and an exponential taper is around 150 μm However, in having a ridge height of say 200 μm fabrication tolerances can be accounted for.

By suitable choice of taper, again at some expense of sensitivity, the effective coupling region of absorption can be moved up and down the length of the ridges 108. Accordingly, the effective coupling region can be moved away from inconsistent artifacts in the ridges that arise from the fabrication process. In particular, excess luminescent material 110 may collect at the base of the ridges 108. The increased thickness of the luminescent material 110 at the base of the ridges 108 may be such that no penetration of the analyte can occur and therefore the region is effectively useless. Similarly, the thickness of the luminescent material may be ill-defined at the very tip of the tapered ridge 108. Through a suitable choice of taper, the effective coupling region may be moved to a region uniform, well-defined, reproducible thickness of luminescent material 110.

Additionally, by employing tapered ridges 108, single mode operation of the optical fibre 40 and sensor 120 is made possible due to the efficient coupling that is obtained. Single mode operation is particularly desirable as the incident radiation used to excite the luminescent material 110 may be a top-hat light source in which higher order modes exhibit different intensities due to environmental conditions such as fibre flexing, which could result in unpredictable sensor operation. Additionally, modelling results suggest that different modes have widely different absorption coefficients, which again could result in unpredictable sensor behaviour.

As shown in FIG. 19, the luminescent sensor 120 is fabricated from a silicon substrate 121, such as a silicon wafer, provided with a layer of silicon dioxide 122 on an upper surface 123. The silicon dioxide layer 122 may be formed on the silicon substrate 121 by conventional means, and is preferably formed by PECVD or thermal oxidation of the silicon substrate 121.

The exposed upper surface of the silicon dioxide layer 122 is covered with a greyscale photoresist mask 124, such as chrome-on-glass or HEBS mask The mask 124 is lithographically patterned with a series of concertric grooves 125, 126. The profiles of the grooves 125 formed in a central region of the mask 124 are tapered such that the mask 124 comprises a series of concentric tapered ridges 127. The grooves 126 surrounding the tapered ridges 127 have conventional rectangular profiles. Owing to mask 124 having different shaped grooves 125,126, the subsequent etching of the tapered grooves in the silicon substrate 121 will generally proceed at different rate to that of the rectangular grooves. In order that the subsequent rectangular and tapered grooves formed in the silicon substrate 121 have the same depth, the Angular grooves 126 in the photorsist mask 124 preferably do not extend through the entire mask 124. Instead, the grooves 126 stop short of the silicon dioxide layer 122 to leave a compensation layer. The thickness of the compensation layer will naturally depend, among other things, on the depth of the grooves and ridges to be etched in the silicon substrate 121.

The shape, size and number of tapered ridges 127 formed in the mask 124 may be tailored to suit As noted above, the profile of the tapered ridges 127 is preferably parabolic, polynomial or exponential.

The structure of the greyscale photoresist mask 124 is transferred to the silicon dioxide layer 122 by reactive ion etching, and the structure of the silicon dioxide layer 122 is subsequently trasferred to the upper surface 123 of the silicon substrate 121 by deep reactive ion etching to result in the structure illustrated in FIG. 20. By way of example, each of the grooves 128 formed in the silicon substrate 121 and having a substantially rectangular profile has a depth of around 300 μm and a radial width of 5 μm The separation between neighbouring rectangular grooves 128 is about 5 μm Each tapered ridge 129 formed in the silicon substrate 121 also has a height of around 300 μm and a radial width at the base of around 5 μm. Preferably, there is no separation between neighbouring tapered ridges 129 at their base. The tapered ridges 129 preferably cover E region greater than the core diameter of the optical fibre 40 so that all of the light transmitted by the core 42 is coupled to the subsequent silicon dioxide ridges 108. It will of course be appreciated that the dimensions indicated above are provided by way of example and that the size and shape of the grooves 128 and ridges 129 formed in the silicon substrate 121 may be tailored to suit In the example provided above, the depth of the rectangular grooves 128 and the height of the tapered ridges 129 are substantially similar. However, the height of the ridges 129 may equally be greater and smaller than the depth of the grooves 128.

As detailed above, the height of each ridge 129 is preferably longer than necessary so as to account for fabrication tolerances.

Any passivation layer deposited on the silicon substrate 121 during the deep reactive ion etch is removed and the upper surface of the silicon substrate is oxidised in a manner similar to that described above and illustrated in FIG. 3. As illustrated in FIG. 19, the oxidation process results in a circular disc 130 of silicon dioxide. In addition, a layer of silicon dioxide 131 is formed over the top surface 123 of the silicon substrate 121.

The lower surface 132 of the silicon dioxide disc 130 may not be entirely planar but may instead be rippled due to the oxidation process. The upper surface of the circular disc 130 comprises a series of concentric ridges 108 encompassed by ring 133 which again may be rippled.

The silicon dioxide ridges 108 are thereafter coated with a luminescent material 110. As noted above in the fabrication of the sensor illustrated in FIG. 15, the choice of luminescent material and the thickness of the coating 110 will depend upon (a) the environmental parameter to be measured (b) the method by which the parameter is to be measured and (c) the incident radiation used for excitation. The luminescent coating 110 is preferably applied as a thin film so as to maximise the sensitivity and response of the coating 110 to changes in the environmental parameter to be measured. The luminescent material 110 is preferably applied using chemical vapour deposition, but alternative forms of deposition may also be used, including thermal evaporation, electron beam evaporation, sputtering, ink-jet, electrospraying, and sol gel techniques.

As in the case of the luminescent sensor described above and illustrated in FIG. 15, the silicon dioxide ridges 108 may first be coated with a cladding or antireflective coating (not shown) prior to coating the ridges 108 with the luminescent material 110. Additionally, the luminescent coating 110 may be annealed to improve performance.

A channel 1 13 is then formed in the opposed second surface 134 of the silicon substrate 121. The channel 113 is generally cylindrical in shape and has a diameter sufficient to accommodate an optical fibre. The channel 113 extends the entire length of the silicon substrate 121 and terminates at the silicon dioxide disc 130. The longitudinal axis of the channel 113 is generally parallel and coincident with the longitudinal axis of the concentric ridges 108.

The channel 113 is preferably formed using DRIE owing to the relatively high etch rates and the ability to achieve substantially vertical sidewalls.

As illustrated in FIG. 19, good optical coupling is achieved between the core 42 of the optical fibre 40 and the luminescent material 110 surrounding the silicon dioxide ridges 108 via the silicon dioxide disc 130 which acts as an optical coupling between the optical fibre and the luminescent material 110.

Although in the example describe above, the silicon dioxide ridges 108 are in the form of concentric rings, other structures are again possible, including, but not limited to, a series of planar ridges or a plurality of freestanding columns.

Thus far, the manufacture of two different types of sensor has been described. The first sensor, a pressure sensor, was manufactured from a silicon wafer whilst the second sensor, or luminescent sensor, was manufactured from either a silicon or an SOI wafer. It will be immediately apparent that the pressure sensor and the luminescent sensor, when fabricated from a silicon wafer, may be manufactured from a single silicon wafer. However, both types of sensor may be also be manufactured from a single SOI wafer. Indeed, with the fabrication methods described above several separate sensors for measuring different environmental parameters may be constructed on a single wafer.

When fabricating both types of sensor on a single SOI wafer, the pressure sensor is first manufactured by applying a photoresist mask, or similar, over the SOI wafer and etching through the uppermost silicon layer and silicon dioxide layer to expose a region of the lower silicon substrate layer. The manufacture of the pressure sensor then continues on the exposed area of the silicon substrate as described above. That is, a ring of silicon dioxide is formed in the bulk silicon.

Attention now turns to the manufacture of the luminescent sensor. Following the oxidation of the wafer in forming the pressure sensor, a layer of silicon dioxide now coats the uppermost layer of silicon. Nevertheless, the process for forming the luminescent sensor remains pretty much the same. The only significant difference is that the concentric grooves are now formed on the surface of the silicon dioxide layer and extend the entire depth of both the silicon dioxide layer and the silicon layer. The wafer is then again oxidised to form the silicon dioxide ridges which act to collect and channel the luminescent radiation. Alternatively, the first oxidation step in the manufacture of the pressure sensor may be omitted. In this situation, the two oxidation steps are replaced by a single oxidation process which occurs after all etching of both the pressure sensor and luminescence sensor has taken place to form two separate silicon dioxide regions in the wafer.

Luminescent materials are then selectively deposited using a photoresist lift-off process or ink dropper process, after which the reflective layer of the pressure sensor is defined. This sequence, however, is dependent upon the nature of the materials and the annealing processes used in the fabrication of the sensors. Should cladding of the silicon dioxide ridges be required, a coating of cladding material is selectively deposited prior to the application of the luminescent coating.

The wafer is then annealed to improve the performance of the luminescent material. As mentioned before, UV laser annealing is preferred so that the annealing may be localised. However, where this will not adversely affect other sensors being fabricated on the same wafer, the wafer may be instead be globally annealed.

Finally, individual channels for receiving optical fibres for each sensor are etched on the reverse side of the wafer and are aligned with the individual sensors and their respective silicon dioxide regions.

In addition to the sensors described above, an imaging sensor may also be fabricated in the SOI wafer. The imaging sensor permits radiation external to the sensor to be collected by the sensor and communicated back along an optical fibre. In addition, the imaging sensor may be used to illuminate the region around the sensor and collect images of that region.

The imaging sensor is manufactured by applying a photoresist mask, or similar, over the SOI wafer and etching through the uppermost silicon layer and the silicon dioxide layer to expose a substantially circular region of the lower silicon substrate layer. The etch is preferably isotropic such that the walls of the etched region form an obtuse angle with the exposed surface of the silicon substrate layer. The size of the photoresist mask is chosen such that the diameter of the exposed region of the silicon substrate surface is less than the external diameter of the optical fibre to be received and preferably larger than the core diameter of the optical fibre. A channel is then etched on the reverse side of the SOI wafer. The channel is generally cylindrical in shape and has a diameter sufficient to accommodate an optical fibre. The channel extends the entire length of the lower silicon substrate and terminates at the silicon dioxide layer. The centre of the channel generally corresponds with the centre of the etched region formed in the uppermost silicon layer and silicon dioxide layer of the wafer. Thus, the aperture in the silicon dioxide layer functions as an optical coupling between an optical fibre located within the channel and the region beyond the upper surface of the wafer.

Whilst reference has been made to etching the uppermost layers of the SOI wafer to expose a circular region of the silicon substrate layer, it will be appreciated that the exposed region may be of any shape and size so long as the optic fibre is prevented from passing entirely through the sensor when inserted into the channel.

Alternatively, the imaging sensor may be formed in the same manner as that employed for forming the pressure sensor. However, in forming the imaging sensor, the step of applying a reflector is omitted.

Whilst each sensor formed on the SOI wafer has thus far been described as having its own channel etched on the reverse side of the SOI wafer for receiving an optical fibre, a single channel may instead be etched on the reverse side of the SOI wafer for all sensors The single channel extends the entire length of the lower silicon substrate and terminates at the silicon dioxide layer of each sensor. The single channel has a diameter sufficient to receive a single optical fibre having a core diameter suitable for optically coupling with each sensor. It will of course be appreciated that with this embodiment a multi-mode optical fibre is preferred.

Accordingly, a plurality of sensors maybe formed on a common substrate. The sensors may be connected to a plurality or bundle of optical fibres, each optical fibre being associated with one sensor, or the sensors may be connected to single optical fibre. In either case, the optical fibre may be single or multi-mode.

The most common method of securing an optical fibre within a channel formed in a silicon substrate is to apply a ring of adhesive about the fibre which bonds with the surface of the silicon substrate and the fibre. However, repeated small displacements of the optical fibre with respect to the substrate over time can cause the adhesive to become separated from the substrate surface.

With reference to FIG. 21, in order to better secure the fibre 40 to the silicon substrate 101, an annular groove 111 may be formed in the surface 12′ of the silicon substrate or silicon block 101 adjacent the opening of the channel 22. When the adhesive 112 (e.g. UV curable adhesive) is applied to the substrate 101 to secure the fibre 40, the adhesive 112 fills the annular groove 111. When cured, the adhesive 112 in the annular groove 111 further inhibits separation of the adhesive 112 from the substrate surface 12′ due to displacements parallel to the surface 12′ of the silicon substrate 101. Furthermore, the width of the groove at the surface 12′ of the substrate 101 is preferably less than the width of the groove below the surface 12′ of the substrate such that displacements perpendicular to the substrate surface 12′ are also further inhibited.

Whilst the groove 111 is preferably annular with a closed profile, it will be appreciated that other shaped grooves having alternative profiles may be employed Moreover, the same technical effect may be achieved with one or more notches formed in the silicon substrate 101 at positions near the channel opening.

By employing the methods described above, several sensors may be manufactured on a single wafer. Each sensor may be adapted to measure a different environmental parameter. For example, the wafer may comprise several luminescent sensors, each having a different luminescent material for measuring parameters such as temperature, fluid flow, pH, oxygen concentration, carbon dioxide concentration, glucose concentration, lactate concentration, bicarbonate ion concentration, chlorine ion concentration, sodium and potassium ion concentration, etc. Different pressure sensors may be employed having different pressure membranes and/or cavity lengths for measuring different pressure ranges.

It is anticipated that the sensors will have practical applications in the field of medicine, particularly where sensors having quick (sub-minute) response times can be vital. With the present invention, sensors having a sub-millimetre diameter are possible making the sensors suitable for mounting on the end of an in vivo probe, such as an endoscope.

The sensors may be used in in vivo patient monitoring, such as that performed in intensive care units, elective surgery and anaesthetics. The sensors may also be used in conjunction with drug delivery systems arranged in feedback, such that drug delivery is controlled according to measurements made by the sensors. The sensors may also be used to assess particular medical conditions. For example, metabolic and hormone levels can be monitored using these sensors which is of use in assessing fertility levels. The sensors may also be of use in the field of psychiatry by measuring, for example, the levels of neurotransmitters such as serotonin.

It is possible that materials used to measure in vivo properties may be toxic. Accordingly, the sensor may be encapsulated by a container of non-toxic material having at least one valve, or closable aperture, for permitting the ingress of an external fluid. When a measurement is to be made, the valve is opened to receive the fluid. Preferably, the container is evacuated and has a one-way inlet valve.

The sensors of the present invention are also suitable for use in food processing. For example, the sensors may be used to probe foodstuffs to measure temperature and/or pH levels.

As the sensors are preferably constructed from monolithic silicon, they can be manufactured using conventional techniques employed in MEMS manufacture. This makes the sensors suitable for mass production. Accordingly, disposable, sterile sensors having low production costs may be manufactured.

The sensor may also be used for a wide variety of applications including but not limited to air conditioning systems (measuring for example temperature, humidity, and CO2 levels), computerised engine tuning systems for vehicles (measuring for example the temperature and composition of the exhaust), EMP and EMC test facilities.

1. A method of fabricating an optical sensor comprising the steps of:
providing a silicon substrate having a first surface and a second surface;
providing a region comprising essentially of silicon dioxide on or in the first surface of the silicon substrate;
etching a channel into the silicon substrate from said second surface up to said silicon dioxide region, said channel being sized to receive an optical fibre whereby said silicon dioxide region forms an end portion of said channel which at least partially closes said channel; and
coating at least a portion of the silicon dioxide region with a coating to form an environmentally-sensitive element.

2. A method of fabricating an optical sensor as claimed in claim 1, wherein the silicon substrate and silicon dioxide region form a single substrate element.

3. A method of fabricating an optical sensor as claimed in claim 1, wherein the silicon substrate is monolithic.

4. A method of fabricating an optical sensor as claimed in claim 1, wherein the step of providing said silicon dioxide region comprises oxidising a portion of said first surface of said silicon substrate.

5. A method of fabricating an optical sensor as claimed in claim 1, wherein the step of providing said silicon dioxide region comprises etching at least one continuous groove in the first surface of said silicon substrate and thereafter forming silicon dioxide in said at least one continuous groove.

6. A method of fabricating an optical sensor as claimed in claim 1, further comprising the step of forming at least one projection comprising essentially of silicon dioxide on said silicon dioxide region.

7. A method of fabricating an optical sensor as claimed in claim 6, wherein the step of forming at least one projection comprises providing a layer of silicon over said silicon dioxide region; etching the layer of the silicon to form at least one structure projecting outwardly from said silicon dioxide region; and thereafter oxidising the at least one structure to form said at least one projection.

8. A method of fabricating an optical sensor as claimed in claim 6, wherein the step of forming at least one projection comprises etching the first surface of said silicon substrate to form at least one structure projecting outwardly from the silicon substrate and thereafter oxidising at least a portion of the first surface of said silicon substrate including the projecting structure to form said silicon dioxide region and said at least one projection.

9. A method of fabricating an optical sensor as claimed in claim 7, wherein the step of etching the silicon comprises etching at least two concentric grooves to form one or more continuous projecting walls.

10. A method of fabricating an optical sensor as claimed in claim 7, wherein the step of etching the silicon comprises etching two or more linear parallel grooves to form at least one planar projecting wall.

11. A method of fabricating an optical sensor as claimed in claim 7, wherein the step of etching the silicon comprises etching a plurality of enclosed grooves to form a plurality of freestanding projections.

12. A method of fabricating an optical sensor as claimed in claim 6, wherein the profile of the silicon dioxide projection is tapered.

13. A method of fabricating an optical sensor as claimed in claim 1, wherein the step of coating at least a portion of the silicon dioxide region to form an environmentally-sensitive element comprises coating at least a portion of the silicon dioxide region with a luminescent material.

14. A method of fabricating an optical sensor as claimed in claim 1, wherein the silicon dioxide region includes a shoulder to define a constriction at the end portion of the channel and the step of coating at least a portion of the silicon dioxide region to form an environmentally-sensitive element comprises coating a region of silicon dioxide that closes the constricted end of the channel with a reflective material.

15. A method of fabricating an optical sensor as claimed in claim 14, further comprising the step of etching a region of silicon dioxide that closes the constricted end of the channel after the reflective material has been applied.

16. A method of manufacturing a sensor comprising the steps of:
providing a silicon wafer;
forming at least one continuous groove in a first surface of the silicon wafer;
forming silicon dioxide in said continuous groove and over the surface area of the silicon wafer encompassed by the continuous groove to form a layer of silicon dioxide;
forming a channel in the silicon wafer extending from an opposed second surface of the silicon wafer up to the base of the continuous groove containing silicon dioxide and forming a cavity beyond the channel in which the wall of the cavity is defined by the silicon dioxide provided in the continuous groove, the longitudinal axis of the channel and the cavity substantially intersecting the point of centre of the continuous groove; and
applying a reflector over at least the layer of silicon dioxide encompassed by the continuous groove.

17. The method as claimed in claim 16, wherein the step of forming the continuous groove in the silicon wafer comprises applying a mask having a ring aperture over the first surface of the silicon wafer and etching exposed regions of the first surface to form an annular groove.

18. The method as claimed in claim 16, wherein a plurality of concentric continuous grooves are formed in the first surface of the silicon wafer, each groove having a thickness and being separation from an adjacent groove a distance selected such that oxidation of the first surface of the silicon wafer including the plurality of concentric grooves produces a silicon dioxide torus in the first surface of the silicon wafer.

19. The method as claimed in claim 16, wherein the step of applying a reflector comprises coating at least the silicon dioxide layer encompassed by the continuous groove with a thin reflective film.

20. The method as claimed in claim 16, further comprising the step of removing at least the silicon dioxide layer encompassed by the continuous groove after the reflector has been applied.

21. A method of manufacturing a sensor comprising the steps of:
providing a silicon wafer having a first surface and a second opposed surface;
forming a depression in the first surface of the silicon wafer;
forming silicon dioxide over the surface of the depression and at least a region of the silicon surface surrounding the depression to form a silicon dioxide membrane surrounded by a region of silicon dioxide;
etching the opposed second surface of the silicon wafer up to the silicon dioxide to fully expose the silicon dioxide membrane; and
coating the silicon dioxide membrane with a reflector, wherein the silicon dioxide region serves as a fibre supporting structure for an end of an optical fibre.

22. A method of manufacturing a sensor comprising the steps of:
providing a silicon-silicon dioxide-silicon wafer;
etching an upper surface of the silicon-silicon dioxide-silicon wafer to form at least one silicon projection;
oxidising at least a portion of the exposed upper surface of the wafer including the silicon projection so as to form at least one silicon dioxide projection;
coating at least a portion of the silicon dioxide projection with a luminescent material; and
forming a channel in the opposed surface of the silicon-silicon dioxide-silicon wafer as far as the silicon dioxide layer, the longitudinal axis of the channel being substantially aligned with the silicon dioxide projection.

23. A method of manufacturing a sensor comprising the steps of:
providing a silicon wafer having a first surface and a second opposed surface;
etching the first surface of the silicon wafer to form at least one silicon projection;
oxidising at least a portion of the first surface of said silicon substrate including the silicon projection to form a silicon dioxide layer and a silicon dioxide projection;
coating at least a portion of the silicon dioxide projection with a luminescent material; and
forming a channel in the second surface of the silicon wafer as far as the silicon dioxide layer, the longitudinal axis of the channel being substantially aligned with the silicon dioxide projection.

24. The method as claimed in claim 22, wherein the profile of the silicon dioxide projection is tapered.

25. A method of fabricating a plurality of optical sensors on a common substrate comprising the steps of:
providing a silicon substrate having a first surface and a second surface;
providing at least two regions each comprising essentially of silicon dioxide on or in the first surface of the silicon substrate;
coating at least a portion of each silicon dioxide region with a coating to form an environmentally-sensitive element; and
etching at least one channel into the silicon substrate from said second surface up to one or more of said silicon dioxide regions, the channel being sized to receive an optical fibre whereby said one or more silicon dioxide region forms an end portion of the channel which at least partially closes said channel.

26. A method of fabricating a plurality of optical sensors as claimed in claim 25, wherein the step of etching at least one channel comprises etching a plurality of channels, each channel being sized to receive an optical fibre and whereby each silicon dioxide region forms an end portion of the respective channel which at least partially closes said channel.

27. A method of fabricating a plurality of optical sensors as claimed in claim 25, wherein the step of etching at least one channel comprises etching a single channel optically coupled to each environmentally-sensitive element.

28. An optical sensor comprising:
a silicon substrate having a first surface and an opposed second surface;
a channel extending into the silicon substrate from said second surface, said channel being sized to receive an optical fibre and having an end portion distant from said second surface, said end portion at least partially closing said channel and comprising essentially of silicon dioxide; and
a coating disposed over at least a region of the silicon dioxide to define an environmentally-sensitive element.

29. An optical sensor as claimed in claim 28, wherein the silicon substrate and silicon dioxide forms a single substrate element.

30. An optical sensor as claimed in claim 28, wherein the silicon dioxide includes a shoulder to define a constriction at the end portion of the channel and the coating comprises a reflective material that covers a region of silicon dioxide that closes the constricted end of the channel.

31. An optical sensor as claimed in claim 28, wherein the silicon dioxide only partially closes the channel to create an opening in the end portion of the channel and the coating comprises a reflective material that covers a region of silicon dioxide surrounding the opening and extends over the opening.

32. An optical sensor as claimed in claim 28, wherein said silicon dioxide comprises at least one projection and the coating is a luminescent coating applied over at least a portion of the at least one projection.

33. A sensor comprising a silicon wafer having a cavity in a first surface covered by a reflector and a channel extending from an opposed second surface of the silicon wafer to the cavity and being in communication therewith, the diameter of the channel being greater than the diameter of the cavity and the end of the channel adjacent the cavity comprising essentially of silicon dioxide.

34. A sensor as claimed in claim 33, wherein the reflector comprises a thin metal film.

35. A sensor as claimed in claim 33, wherein the reflector comprises a dielectric stack.

36. A sensor comprising a silicon wafer having at least a region of a first surface of the silicon wafer covered by a layer of silicon dioxide and at least one structure comprising essentially of silicon dioxide projecting outwardly from the silicon dioxide layer and having a luminescent material covering at least a portion of said silicon dioxide structure and a channel extending from an opposed second surface of the silicon wafer to said silicon dioxide layer and aligned with said silicon dioxide structure.

37. A sensor as claimed in claim 36, wherein the profile of said silicon dioxide structure is tapered.

38. A sensor system comprising a plurality of optical sensors on a common substrate having a first surface and an opposing second surface and a channel extending into the common substrate from said second surface, said channel being sized to receive an optical fibre, each optical sensor comprising:
an end portion distant from said second surface at least partially closing said channel and comprising essentially of silicon dioxide;
an optical coupling associated with said end portion; and
at least one of said optical sensors further comprising an environmentally-sensitive element for optical coupling with an optical fibre by means of said optical coupling.

39. A sensor system comprising a common substrate of monolithic silicon having a first surface and an opposing second surface and at least one pressure sensor and at least one optical sensor for measuring a parameter selected from temperature, fluid flow, pH, oxygen concentration, carbon dioxide concentration, glucose concentration, lactate concentration, bicarbonate ion concentration, chlorine ion concentration, sodium and potassium ion concentration,
the pressure sensor comprising:
a cavity formed in the first surface of the substrate covered by a reflector and a channel extending from the second surface of the substrate to the cavity and being in communication therewith, the diameter of the channel being greater than the diameter of the cavity and the end of the channel adjacent the cavity comprising essentially of silicon dioxide;
and the optical sensor comprising:
a layer of silicon dioxide covering at least a region of the first surface of the substrate and at least one structure comprising essentially of silicon dioxide projecting outwardly from the silicon dioxide layer and having a luminescent material covering at least a portion of said silicon dioxide structure and a channel extending from the second surface of the substrate to said silicon dioxide layer and aligned with said silicon dioxide structure.

40. A method of securing an optical fibre to a silicon block, the method comprising the steps of:
forming a channel extending into the silicon block from a surface of the block, the channel being sized so as to accommodate an end of the optical fibre;
forming an aperture in the surface of the silicon block adjacent the opening of the channel in the surface of the silicon block;
inserting an optical fibre into the channel; and
applying an adhesive to the optical fibre and to the surface of the silicon block adjacent the optical fibre and including into the adjacent aperture.

41. The method as claimed in claim 40, wherein the aperture is an annular groove encircling the opening to the channel.

42. The method as claimed in claim 40, wherein the width of the aperture at the surface of the silicon block is less than the width of the aperture below the surface of the silicon block.
